(19) United States
(12) Patent Application Publication
(10) Pub. No.: US 2026/0053093 A1
(43) Pub. Date: Feb. 26, 2026

(54) INTEGRATED HARVESTING DEVICE FOR PICKING AND SORTING FAMOUS TEA

(71) Applicant: Zhejiang University, Hangzhou City (CN)

(72) Inventors: Xiaoli LI, Hangzhou City (CN); Yong HE, Hangzhou City (CN); Xuechen ZHANG, Hangzhou City (CN); Sitan YE, Hangzhou City (CN); Liang HE, Hangzhou City (CN); Xinan FAN, Hangzhou City (CN)

(21) Appl. No.: 19/024,927

(22) Filed: Jan. 16, 2025

(30) Foreign Application Priority Data
Aug. 26, 2024 (CN) 2024111699530

(51) Int. Cl. A01D 46/30; A01D 46/04; A01D 69/02; G06V 20/10

(52) U.S. Cl. CPC A01D 46/30; A01D 46/04; A01D 69/02; G06V 20/188

(57) ABSTRACT

Provided is an integrated harvesting device for picking and sorting famous tea. The device includes a frame, a control module, and a traveling module, a picking module, a conveying module, a sorting module, a collecting module and a visual detection module which are electrically connected to the control module. The traveling module is installed at a lower end of the frame, the picking module is installed on the frame and arranged adjacent to a front end and the lower end of the frame. The picking module can pick tea leaves with assistance of the visual detection module. The conveying module and the sorting module are both installed on the frame, the conveying module is configured to convey tea leaves picked by the picking module to the sorting module.

### CROSS-REFERENCE TO RELATED APPLICATIONS

This patent application claims the benefit and priority of Chinese Patent Application No. 2024111699530 filed with the China National Intellectual Property Administration on Aug. 26, 2024, the disclosure of which is incorporated by reference herein in its entirety as part of the present application.

### FIELD OF INVENTION

The present disclosure relates to the technical field of harvesting of tea leaves, and in particular to an integrated harvesting device for picking and sorting famous tea.

### BACKGROUND

In general, tea picking is divided into manual picking and machine picking. Although the tea grade can be sorted during manual picking, the picking efficiency is low, the sorting efficiency is low, and labor is wasted. However, the traditional tea picking machine basically has no sorting function, making the picked tea leaves varied in quality, the tea leaves still need to be manually sorted, which still has the problem of wasting labor.

### SUMMARY OF THE INVENTION

An objective of the present disclosure is to provide an integrated harvesting device for picking and sorting famous tea, so as to solve the problems in the prior art, thereby realizing picking and sorting of famous tea, improving picking efficiency of the tea, and saving labor.

To achieve the objective above, the present disclosure proposes the following technical solution:

An integrated harvesting device for picking and sorting famous tea includes a frame, a control module, and a traveling module, a picking module, a conveying module, a sorting module, a collecting module and a visual detection module which are electrically connected to the control module. The traveling module is installed at a lower end of the frame, the picking module is installed on the frame and arranged adjacent to a front end and the lower end of the frame; the picking module is able to pick tea leaves with assistance of the visual detection module; the conveying module and the sorting module are both installed on the frame, the conveying module is configured to convey tea leaves picked by the picking module to the sorting module; the sorting module is configured to sort the tea leaves with assistance of the visual detection module, and enable sorted famous tea and ordinary tea leaves to enter different boxes in the collecting module.

In some embodiments, the control module includes a power supply, and a controller; the power supply is electrically connected to the controller and configured to provide electric energy; the controller is electrically connected to the traveling module, the picking module, the conveying module, the sorting module, the collecting module, and the visual detection module.

In some embodiments, the traveling module includes two crawler wheel boxes and four traveling units; two of the four traveling units, which are located on a same side, are externally mounted with one of the two crawler wheel boxes, the four traveling units are respectively installed at four corners of the frame; the four traveling units include direct current gear motors, gear chain sets, and crawler wheel sets; the direct current gear motors are installed at the lower end of the frame, output shafts of the direct current gear motors are connected to the gear chain sets, and the gear chain sets are further connected to the crawler wheel sets; each of the two crawler wheel boxes is covered on a periphery of corresponding two of the crawler wheel sets on the same side, and lower ends of the crawler wheel sets extend out of the crawler wheel boxes.

In some embodiments, the picking module includes multiple picking units arranged in sequence in a direction perpendicular to an advancing direction; each of the multiple picking units includes a translation element, a transverse sliding table, a first lifting element, a first vertical sliding table, and a picking part; the translation element is parallel to the advancing direction, and the transverse sliding table is movably installed on the translation element and capable of moving in a horizontal direction; an upper end of the first lifting element is connected to the transverse sliding table; the first vertical sliding table is movably installed on the first lifting element and capable of raising and lowering in a vertical direction; and the first vertical sliding table is connected to the picking part, and the multiple picking units are able to pick the tea leaves.

In some embodiments, the picking part includes a gathering guide groove, a shunting baffle, a second lifting element, a second vertical sliding table, a brushless motor, and a blade set; the gathering guide groove, the shunting baffle and the second lifting element are installed on the first vertical sliding table; the shunting baffle includes two shunting unit plates; ends of the two shunting unit plates are fixedly connected to form a guide angle facing the front end of the frame; from the front end to a rear end of the frame, the two shunting unit plates extend in directions away from each other, and then extend parallel to each other; the guide angle is located at a middle part of the gathering guide groove, an other end of each of the two shunting unit plates extends to be flush with an end of the gathering guide groove, and the two shunting unit plates respectively form two picking grooves with inner walls of the gathering guide groove; the second vertical sliding table is movably installed on the second lifting element and capable of raising and lowering in the vertical direction; the brushless motor is installed on the second vertical sliding table, and an output shaft of the brushless motor extends out between the two shunting unit plates and is connected to the blade set; an other end of the gathering guide groove is configured for the tea leaves to enter, the guide angle is configured to divide the tea leaves entering the gathering guide groove into two groups, and enable the two groups of the tea leaves to respectively enter the two picking grooves; and the blade set is configured to cut and pick the tea leaves in the two picking grooves.

In some embodiments, each of the translation element, the first lifting element and the second lifting element is a lead screw-guide rail set.

In some embodiments, two air compressors are respectively installed on two sides of the lower end of the frame, each of the air compressors is connected to a wind box, multiple first air ducts and multiple second air ducts are respectively connected to the two air compressors, an end of each of the multiple first air ducts extends to the picking module, and is configured to blow tea leaves picked by the picking module to the conveying module; and an end of each of the multiple second air ducts extends to the sorting module, and is configured to blow different grades of tea leaves at the sorting module to different boxes in the collecting module according to tea grade information detected by the visual detection module.

In some embodiments, the conveying module includes a telescopic sliding plate, a first conveyor belt and a second conveyor belt which are installed on the frame; an end of the telescopic sliding plate is arranged adjacent to the picking module, the telescopic sliding plate is able to extend and retract in an advancing direction, and an other end of the telescopic sliding plate extends to an end of the first conveyor belt; the multiple first air ducts are able to blow the tea leaves picked by the picking module to the telescopic sliding plate and the first conveyor belt, an other end of the first conveyor belt extends to a lower end of the second conveyor belt, and an upper end of the second conveyor belt extends to a position above the sorting module; in the advancing direction, a height of the first conveyor belt decreases gradually, multiple first baffles perpendicular to a surface of the first conveyor belt are equidistantly distributed on the surface of the first conveyor belt, a length direction of the multiple first baffles is perpendicular to the advancing direction; the multiple first baffles are able to convey the tea leaves to the second conveyor belt; multiple second baffles perpendicular to a surface of the second conveyor belt are equidistantly distributed on the surface of the second conveyor belt, and a length direction of the multiple second baffles is perpendicular to the advancing direction; inclined plates are connected to ends, away from the surface of the second conveyor belt, of the multiple second baffles, an included angle between each of the inclined plates and a corresponding one of the multiple second baffles is an obtuse angle, and the inclined plates and the multiple second baffles are able to drive the tea leaves to move upwards to fall on the sorting module.

In some embodiments, the visual detection module includes color cameras, a hyperspectral camera, and a structured light camera; the color cameras are installed adjacent to the sorting module and configured to detect quality of the tea leaves; the hyperspectral camera and the structured light camera are arranged adjacent to the picking module; the hyperspectral camera is configured to identify bud heads of the tea leaves on a canopy; and the structured light camera is configured to position the bud heads of the tea leaves on the canopy.

In some embodiments, the sorting module includes an electromagnetic vibration feeder, an isolation bracket, a sorting cover, light-emitting diode (LED) strips, background plates, and two groups of air-blowing port brackets; a periphery of the isolation bracket is covered with the sorting cover, the tea leaves at a discharge port of the electromagnetic vibration feeder are able to enter the isolation bracket; the collecting module includes two collecting boxes, and an inclined slideway is arranged between the two collecting boxes; the isolation bracket is installed at an upper end of the inclined slideway, and the two collecting boxes are located at two sides of a lower end of the isolation bracket, respectively; the inclined slideway is able to communicate with an internal of the isolation bracket, the two groups of air-blowing port brackets are symmetrically installed on the isolation bracket and in communication with the multiple second air ducts, and the air-blowing port brackets are in one-to-one correspondence with the collecting boxes; the air-blowing port brackets are configured to blow the tea leaves into corresponding collecting boxes with assistance of the color cameras; and when the two groups of air-blowing port brackets are not at operation, the tea leaves fall into the inclined slideway; multiple feeding grooves are formed in an upper surface of the electromagnetic vibration feeder, which are in one-to-one correspondence with the color cameras, and the color cameras are installed at an upper end of the isolation bracket and arranged adjacent to discharge ports of the feeding grooves; the LED strips include two groups of LED strips, the two groups of LED strips are installed on the isolation bracket and are respectively located at upper and lower sides of the color cameras; and the background plates are installed on the isolation bracket and is opposite to the color cameras.

Compared with the prior art, the present disclosure achieves the following technical effects:
1. According to an integrated harvesting device for picking and sorting famous tea provided by the present disclosure, an entire height of each picking unit and a height of a blade set can be independently adjusted. Compared with the traditional integrated picking device with a constant height, the device provided by the present disclosure can effectively adapt to tea picking in a tea garden with an arc-shaped tea canopy, a tea garden with a planar tea canopy and a tea garden with an irregular-shaped tea canopy with ups and downs with the assistance of the hyperspectral camera and the structured light camera, so that the universality of the picking device is significantly improved. In addition, two picking methods can be selected: the picking part continuously picks tea leaves with the advance of the device, and the picking part moves along the translation element for picking after the device stops, which are respectively suitable for tea picking in standardized tea gardens and non-standardized tea gardens, and can improve the picking quality of tea leaves.
2. According to the integrated harvesting device for picking and sorting famous tea provided by the present disclosure, the sorting module arranged at the top of the device is configured to sort the picked fresh tea leaves in time, effectively sort the fresh tea leaves into one bud with one leaf and one bud with two leaves, and discharge the rest impurities. Compared with the traditional one-size-fits-all tea picking device, the uniformity of the picked fresh tea leaves is improved, the impurities in the tea leaves are reduced, and the quality of the picked fresh tea leaves is improved.
3. According to the integrated harvesting device for picking and sorting famous tea provided by the present disclosure, the visual-guided continuous and fine tea picking and high-speed color selection and grading of tea leaves are integrated into one device. After positioning fresh tea leaves by visual recognition, the tea leaves are gathered by the gathering guide grooves. The tea leaves are continuously picked by adjusting a height of the blade set, and the picked tea leaves are sorted to different grades by color cameras in a short time, which effectively improves the picking quality and efficiency of tea leaves, solves the problem of poor sorting accuracy caused by water loss after fresh tea leaves are picked, and improves the quality of the picked fresh tea leaves.

### BRIEF DESCRIPTION OF THE DRAWINGS

To describe the technical solutions of the embodiments of the present disclosure or in the prior art more clearly, the following briefly introduces the accompanying drawings required for describing the embodiments. Apparently, the accompanying drawings in the following description show merely some embodiments of the present disclosure, and those of ordinary skill in the art may still derive other drawings from these accompanying drawings without creative efforts.

FIG. 1 is a schematic structural diagram of an integrated harvesting device for picking and sorting famous tea according to the present disclosure;

FIG. 2 is a schematic structural diagram of a picking module according to the present disclosure;

FIG. 3 is a schematic structural diagram of a sorting module according to the present disclosure;

FIG. 4 is a side view of FIG. 3;

FIG. 5 is a schematic diagram of an integrated harvesting device for picking and sorting famous tea according to the present disclosure during standardized picking;

FIG. 6 is a diagram showing movement trajectories of a gathering guide groove and a blade set according to the present disclosure;

FIG. 7 is a schematic diagram of an integrated harvesting device for picking and sorting famous tea according to the present disclosure when adapting to tea canopies with different shapes; and

FIG. 8 is a schematic diagram of dividing picking areas through color cameras and planning picking height trajectories of picking parts of an array based on depth information according to the present disclosure.

In the drawings: 1 sorting cover; 2 color camera; 3 background plate; 4 second LED strip; 5 first air-blowing port bracket; 6 power supply; 7 frame; 8 second air duct; 9 translation element; 10 hyperspectral camera; 11 structured light camera; 12 picking module; 13 air compressor; 14 direct current gear motor; 15 crawler wheel box; 16 crawler wheel set; 17 second conveyor belt; 18 first collecting box; 19 inclined slideway; 20 second collecting box; 21 first conveyor belt; 22 telescopic sliding plate; 23 transverse sliding table; 24 first lifting element; 25 first air duct; 26 first vertical sliding table; 27 second lifting element; 28 second vertical sliding table; 29 air outlet; 30 brushless motor; 31 gathering guide groove; 32 shunting baffle; 33 blade set; 34 electromagnetic vibration feeder; 35 first LED strip; 36 second baffle; 37 first baffle; 38 second air-blowing port bracket

### DETAILED DESCRIPTION OF EMBODIMENTS

The following clearly and completely describes the technical solutions in the embodiments of the present disclosure with reference to the accompanying drawings in the embodiments of the present disclosure. Apparently, the described embodiments are merely a part rather than all of the embodiments of the present disclosure. All other embodiments obtained by those of ordinary skill in the art based on the embodiments of the present disclosure without creative efforts shall fall within the scope of protection of the present disclosure.

An objective of the present disclosure is to provide an integrated harvesting device for picking and sorting famous tea, so as to solve the problems in the prior art, thereby realizing picking and sorting of famous tea, improving picking efficiency of the tea, and saving labor.

In order to make the objectives, features and advantages of the present disclosure more clearly, the present disclosure is further described in detail below with reference to the accompanying drawings and specific embodiments.

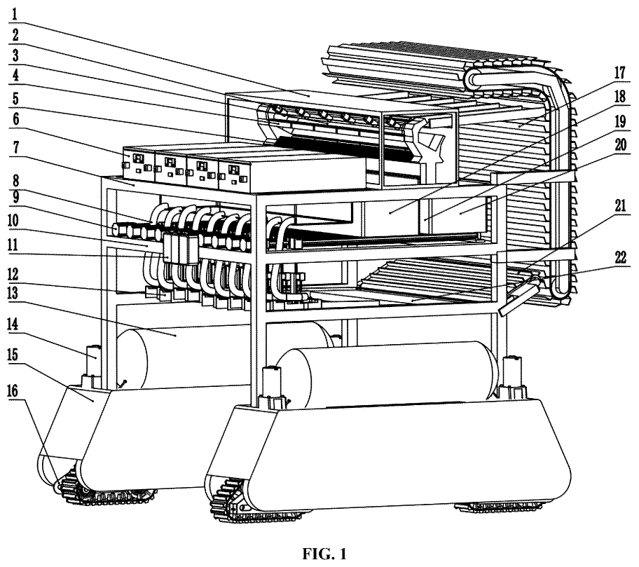

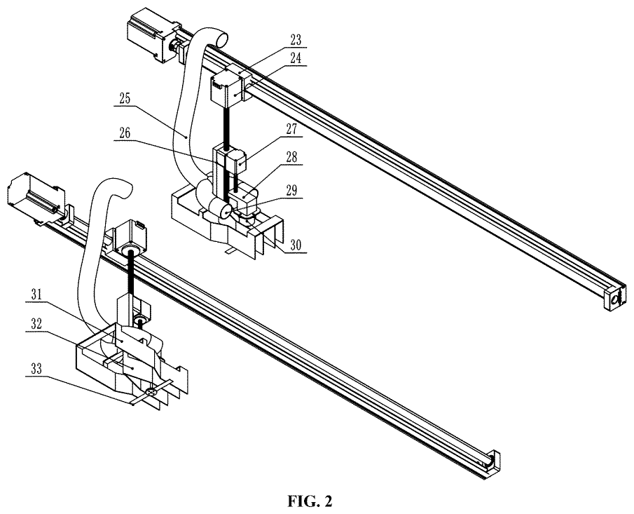

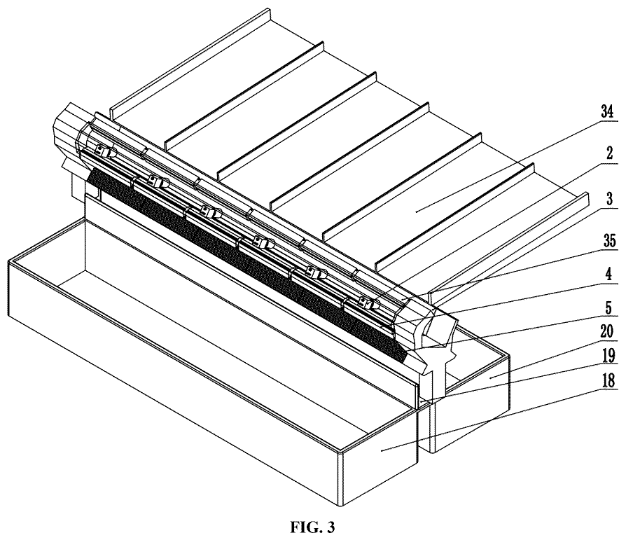

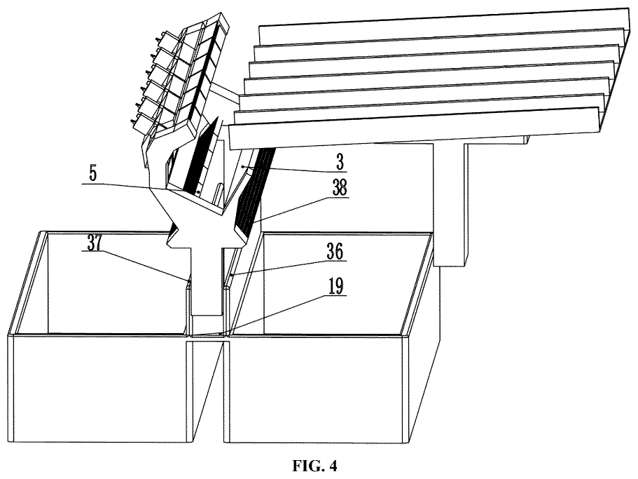

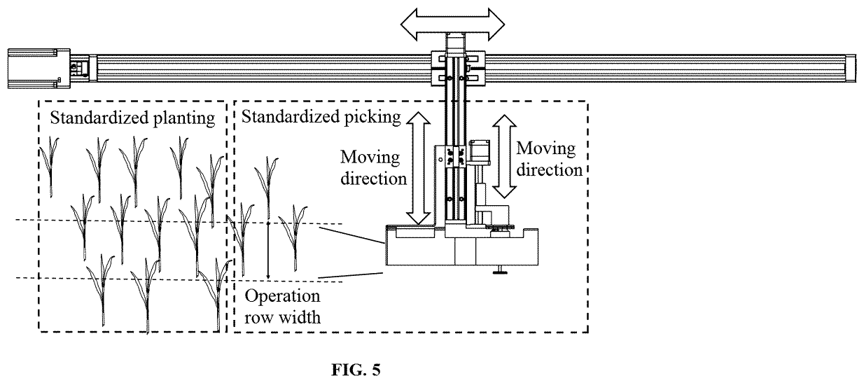

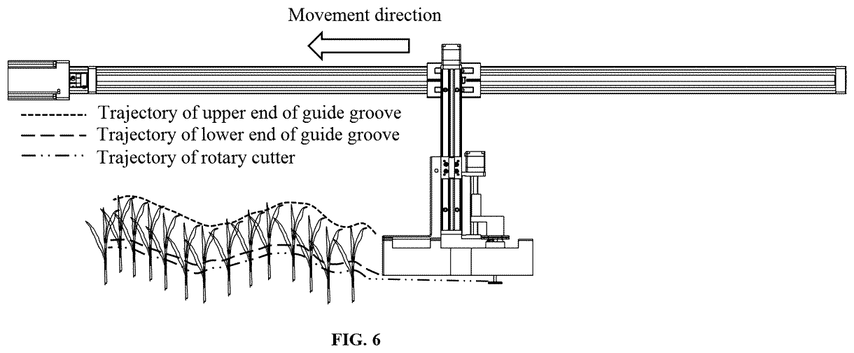

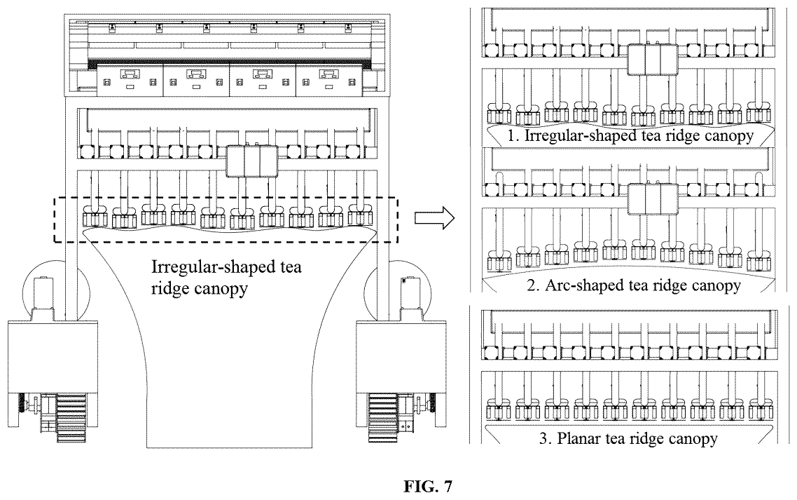

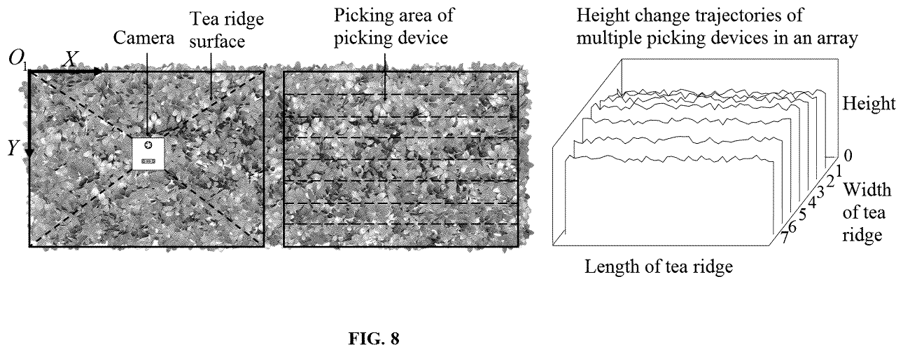

As shown in FIG. 1 to FIG. 8, this embodiment provides an integrated harvesting device for picking and sorting famous tea. The integrated harvesting device for picking and sorting famous tea includes a frame 7, a control module, and a traveling module, a picking module 12, a conveying module, a sorting module, a collecting module and a visual detection module which are electrically connected to the control module. The traveling module is installed at a lower end of the frame 7, the picking module 12 is installed on the frame 7 and arranged adjacent to a front end and the lower end of the frame 7. The picking module 12 can pick tea leaves with the assistance of the visual detection module. The conveying module and the sorting module are both installed on the frame 7, the conveying module is configured to convey tea leaves picked by the picking module 12 to the sorting module. The sorting module is configured to sort the tea leaves with the assistance of the visual detection module, and enable sorted famous tea and ordinary tea leaves to enter different boxes in the collecting module.

Specifically, the control module includes a power supply 6, and a controller. The power supply 6 is electrically connected to the controller and configured to provide electric energy. The power supply 6 is multiple groups of lithium batteries arranged at a front side of the top of the frame 7. The controller is electrically connected to the traveling module, the picking module 12, the conveying module, the sorting module, the collecting module, and the visual detection module.

The traveling module includes two crawler wheel boxes 15, and four traveling units. Two traveling units, which are located on the same side, are externally mounted with a same crawler wheel box. The four traveling units are respectively installed at four corners of the frame 7. The traveling unit includes a direct current gear motor 14, a gear chain set, and a crawler wheel set 16. The crawler wheel set 16 is a triangular crawler travel wheel set. The direct current gear motor 14 is installed at the lower end of the frame 7, an output shaft of the direct current gear motor 14 is connected to the gear chain set, and the gear chain set is further connected to the crawler wheel set 16. The crawler wheel box 15 is covered on a periphery of the two crawler wheel sets 16 on the same side, and lower ends of the crawler wheel sets 16 extend out of the crawler wheel box 15. Each crawler wheel set 16 is driven by the direct current gear motor 14 through the gear chain set. The crawler wheel set 16 is configured to achieve the traveling of the integrated harvesting device for picking and sorting famous tea in the hilly and mountain area.

The picking module 12 includes multiple picking units arranged in sequence in a direction perpendicular to an advancing direction, and a picking direction of the picking unit is consistent with the advancing direction. The picking unit includes a translation element 9, a transverse sliding table 23, a first lifting element 24, a first vertical sliding table 26, and a picking part. The translation element 9 is parallel to the advancing direction, and the transverse sliding table 23 is movably installed on the translation element 9 and capable of moving in a horizontal direction, and the sliding range of the transverse sliding table 23 does not exceed the limit of both ends of the translation element 9. An upper end of the first lifting element 24 is connected to the transverse sliding table 23. The first vertical sliding table 26 is movably installed on the first lifting element 24 and capable of raising and lowering in a vertical direction, and the sliding range of the first vertical sliding table 26 does not exceed the limit of both ends of the first lifting element 24. The first vertical sliding table 26 is connected to the picking part, and the picking unit can pick the tea leaves.

The picking part includes a gathering guide groove 31, a shunting baffle 32, a second lifting element 27, a second vertical sliding table 28, a brushless motor 30, and a blade set 33. The gathering guide groove 31, the shunting baffle 32 and the second lifting element 27 are installed on the first vertical sliding table 26. The shunting baffle 32 includes two shunting unit plates, ends of the two shunting unit plates are fixedly connected to form a guide angle facing the front end of the frame 7. From the front end to a rear end of the frame 7, the two shunting unit plates extend in directions away from each other and then extend parallel to each other. The guide angle is located at a middle part of the gathering guide groove 31, the other ends of the two shunting unit plates extend to be flush with an end of the gathering guide groove 31, and each shunting unit plate forms a picking groove with a corresponding inner wall of the gathering guide groove 31. By designing two picking grooves, the tea leaves can be separated and then gathered, such that the tea leaves can support each other. Moreover, the baffles on both sides of the picking grooves (two sidewalls of the gathering guide groove 31) can provide enough support for the gathered tea leaves. When the blade set 33 rotates at a high speed, the stalks of the tea leaves will not bend greatly, such that the incision is smoother when a cutter is used to cut the stalks of the tea leaves, and the quality of the picked tea leaves is better. In addition, the tea leaves diverted into the picking grooves are free from falling directly due to the mutual support of the tea leaves and the support of the baffles at both sides, and then can be directly blown onto the telescopic sliding plate 22 at the rear through an air outlet 29.

The second vertical sliding table 28 is movably installed on the second lifting element 27 and capable of raising and lowering in the vertical direction. The brushless motor 30 is installed on the second vertical sliding table 28. An output shaft of the brushless motor 30 extends out between two shunting unit plates and is connected to the blade set 33 through a flange. The blade set 33 is driven to move up and down by the up-and-down sliding of the second vertical sliding table 28, thus picking tea leaves with different heights in the area in the gathering guide groove 31. An end of the gathering guide groove 31 is configured for the tea leaves to enter, and the guide angle is configured to divide the tea leaves entering the gathering guide groove 31 into two groups and enable the two groups of tea leaves to respectively enter two picking grooves. The blade set 33 is configured to cut and pick the tea leaves in the picking grooves. An air outlet 29 is arranged above the gathering guide groove 31. The air outlet 29 is connected to a wind box through a first air duct 25 to blow air through the air outlet 29 and blow the picked tea leaves in the gathering guide groove 31 onto the conveying module.

As a specific selection, the gathering guide groove 31 is a semi-open device with a connected upper end and an open lower end. A width of a front section of the gathering guide groove 31 (that is, a position far away from a parallel section of the shunting unit plates) is 12 cm, a width of a rear section is 10 cm. An included angle between the front sections of the two shunting unit plates is 30 degrees. A width of each of the two picking grooves is 2.5 cm. A distance between the two picking grooves (that is, a width of a parallel section between the two shunting unit plates) is 5 cm. The blade set 33 includes two picking blades, and each picking blade has a length of 6 cm. The first air duct 25 is led out from the wind box and fixed above the gathering guide groove 31. The first air duct 25 is divided into two ducts at the bottom of the first lifting element 24 to lead out two air outlets 29. The air outlets 29 are directly above the picking grooves, and configured to blow the fresh tea leaves cut by the blade set 33 onto the telescopic sliding plate 22 at the rear.

Each of the translation element 9, the first lifting element 24 and the second lifting element 27 is a lead screw-guide rail set.

Two air compressors 13 are respectively installed on two sides of the lower end of the frame 7, each air compressor 13 is connected to a wind box, and the wind box is arranged at a front side below the top of the frame 7. Each air compressor 13 is arranged on an upper end of a corresponding crawler wheel box 15 in an inverted manner, and the wind box and the air compressor 13 are used to provide high-pressure airflow for the picking module 12 and the sorting module. Multiple first air ducts 25 and multiple second air ducts 8 are respectively connected to the air compressors 13. An end of the first air duct 25 extends to the picking module 12, and is configured to blow the tea leaves picked by the picking module 12 to the conveying module. An end of the second air duct 8 extends to the sorting module, and is configured to blow different grades of tea leaves at the sorting module to different boxes in the collecting module according to tea grade information detected by the visual detection module.

The conveying module includes a telescopic sliding plate 22, a first conveyor belt 21 and a second conveyor belt 17 which are installed on the frame 7. An end of the telescopic sliding plate 22 is arranged adjacent to the picking module 12, and installed on a third beam of the frame 7. The telescopic sliding plate 22 can be in three-stage extension and retraction in an advancing direction along with the translation of the picking part. As the fresh tea leaves are blown onto the telescopic sliding plate 22 by the air outlet 29, when the translation element 9 moves towards the advancing direction of the device, the telescopic sliding plate 22 extend continuously, and will be covered with tea leaves. When the translation element 9 is reset, the telescopic sliding plate 22 retracts, and the tea leaves on the telescopic sliding plate 22 also fall back to the first conveyor belt 21 with the retraction of the telescopic sliding plate 22.

A tail end of the third beam of the frame 7 is connected to the first conveyor belt 21 through a connecting bracket, such that the other end of the telescopic sliding plate 22 extends to an end of the first conveyor belt 21. The first air ducts 25 can blow the tea leaves picked by the picking module 12 onto the telescopic sliding plate 22 and the first conveyor belt 21, thus conveying the fresh tea leaves backwards through a clapboard type conveyor belt. The other end of the first conveyor belt 21 extends to a lower end of the second conveyor belt 17, two connecting brackets are arranged above a tail end of the rear side of the third beam of the frame 7 and further two connecting brackets are arranged below a tail end of a second beam to fix the second conveyor belt 17. An upper end of the second conveyor belt 17 extends to a position above the sorting module. The second conveyor belt 17 uses a troughed conveyor belt, which can convey the fresh tea leaves upwards to the sorting module. In the advancing direction, the height of the first conveyor belt 21 decreases gradually. Multiple first baffles 37 perpendicular to a surface of the first conveyor belt 21 are equidistantly distributed on the surface of the first conveyor belt 21, a length direction of the first baffles 37 is perpendicular to the advancing direction, and the first baffles 37 can convey the tea leaves to the second conveyor belt 17. Multiple second baffles 36 perpendicular to a surface of the second conveyor belt 17 are equidistantly distributed on the surface of the second conveyor belt 17, and a length direction of the second baffles 36 is perpendicular to the advancing direction. An inclined plate is connected to an end, away from the surface of the second conveyor belt 17, of the second baffle 36, and an included angle between the inclined plate and the second baffle 36 is an obtuse angle. At a transition from the vertical direction of the second conveyor belt 17 to a transverse direction at the upper part, an opening direction of the groove formed by the inclined plate and the second baffle plate 36 is downward, such that the fresh tea leaves can be smoothly discharged to the surface of the electromagnetic vibration feeder 34. During this process, the picked fresh tea leaves are blown by the airflow to the telescopic sliding plate 22 above the second beam of the frame 7. Because of continuous airflow flowing out of the first air duct 25, the fresh tea leaves will slide backwards to the tail of the telescopic sliding plate 22 on the telescopic sliding plate 22 and fall onto the first conveyor belt 21, and the fresh tea leaves are conveyed obliquely upwards with the first conveyor belt 21 to the second conveyor belt 17. The fresh tea leaves are conveyed upwards by the second conveyor belt 17 through the second baffles 36 on the surface and the inclined plates, and are thrown out at the transition between a vertical section and an upper horizontal section of the second conveyor belt 17. The thrown fresh tea leaves fall onto the electromagnetic vibration feeder 34, and then fall downward to enter the sorting module with the high frequency vibration of the electromagnetic vibration feeder 34.

The visual detection module includes color cameras 2, a hyperspectral camera 10, and a structured light camera 11. The color cameras 2 are installed adjacent to the sorting module and configured to detect the quality of the tea leaves, thus achieving the grading of the picked fresh tea leaves conveniently. Through the identification of the color cameras 2, the fresh tea leaves are sorted into one bud with one leaf, and one bud with two leaves. The hyperspectral camera 10 and the structured light camera 11 are arranged adjacent to the picking module 12. The hyperspectral camera 10 and the structured light camera 11 are both installed at a front side of the second beam of the frame 7. The picking module 12 is arranged on the second beam of the frame 7. The hyperspectral camera 10 is configured to identify bud heads of the tea leaves on a canopy, and the structured light camera 11 is configured to position the bud heads of the tea leaves on the canopy.

In this embodiment, an entire height of each picking unit and a height of the blade set 33 can be independently regulated. Compared with the traditional integrated picking device with a constant height, the device in this embodiment can effectively adapt to tea picking in a tea garden with an arc-shaped tea canopy, a tea garden with a planar tea canopy and a tea garden with an irregular-shaped tea canopy with ups and downs with the assistance of the hyperspectral camera 10 and the structured light camera 11, so that the universality of the picking device is significantly improved. In addition, two picking methods can be selected: the picking part continuously picks tea leaves with the advance of the device, and the picking part moves along the translation element 9 for picking after the device stops, which are respectively suitable for tea picking in standardized tea gardens and non-standardized tea gardens, have higher adaptability of tea gardens, and lower requirements for standardization of tea gardens. In addition, in this embodiment, not only the entire height of the picking part can be adjusted in real time with the height of the tea canopy, but also the height of the blade set 33 can be adjusted in real time. The height of the blade set 33 can be adjusted according to the growth heights of tea in different periods, thus improving the uniformity of the picked fresh tea leaves while achieving continuous picking of tea leaves.

In addition, this embodiment can support two picking modes. The first picking mode is continuous picking. In a standardized tea garden, in the process of the entire device advancing at a constant speed, an entire structure of the picking part and the blade set 33 are adjusted in real time according to position information of the tea leaves obtained by the hyperspectral camera 10 and the structured light camera 11 to complete tea picking. The second picking mode is intermittent picking. In a non-standardized tea garden, the device stops after entirely advancing for a fixed distance, a movement trajectory of the picking part is calculated according to the recorded position information of the tea leaves acquired by the hyperspectral camera 10 and the structured light camera 11, attitude information acquired by a gyroscope when the device starts to move forward and attitude information acquired by the gyroscope when the device stops, the picking part moves along the lead screw-guide rail set arranged above the second beam of the frame 7 in an advancing direction of the device, and the height of the picking part and the height of the blade set 33 are adjusted in real time according to the calculated movement trajectory to complete the tea picking.

The sorting module includes an electromagnetic vibration feeder 34, an isolation bracket, a sorting cover 1, LED strips, background plates 3, and two groups of air-blowing port brackets. The electromagnetic vibration feeder is fixed above the middle of a tail end of the third beam of the frame 7 by a connecting bracket. The periphery of the isolation bracket is covered with the sorting cover, the tea leaves at a discharge port of the electromagnetic vibration feeder can enter the isolation bracket. The collecting module is installed at a rear side below the top of the frame 7. The collecting module includes two collecting boxes, and an inclined slideway 19 is arranged between the two collecting boxes. The first baffle 37 and the second baffle 36 are respectively fixed to both sides of an upper end of the inclined slideway. The two collecting boxes are configured to collect the tea leaves, and the inclined slideway 19 is configured to discharge impurities to the field. The isolation bracket is installed at the upper end of the inclined slideway 19, and the two collecting boxes are respectively located at both sides of a lower end of the isolation bracket. The inclined slideway 19 can communicate with the inside of the isolation bracket, and the two groups of air-blowing port brackets are symmetrically installed on the isolation bracket and in communication with the second air ducts 8, the air-blowing port brackets are in one-to-one correspondence with the collecting boxes. The air-blowing port brackets are configured to blow the tea leaves into the corresponding collecting boxes with the assistance of the color cameras 2. When the two groups of air-blowing port brackets are not in operation, the tea leaves fall into the inclined slideway 19. Multiple feeding grooves are formed in an upper surface of the electromagnetic vibration feeder 34, preferably six feeding grooves, thus achieving partitioned feeding of the sorting module. A width of each feeding groove is 20 cm, and one color camera 2 (namely an RGB camera), two LED light strips, one background plate 3 and two symmetrically placed air-blowing port brackets are correspondingly arranged below each feeding groove. The feeding grooves are in one-to-one correspondence with the color cameras 2, and the color cameras 2 are installed at an upper end of the isolation bracket and arranged adjacent to discharge ports of the feeding grooves. There are two groups of LED strips, namely, first LED strips 35 and second LED strips 4. The two groups of LED strips are installed on the isolation bracket and respectively located on upper and lower sides of the color cameras 2. The background plates 3 are installed on the isolation bracket, and are opposite to the color cameras 2. The background plates 3 are blue background plates.

The air-blowing port brackets are divided into first air-blowing port brackets 5 and second air-blowing port brackets 38. The collecting module includes a first collecting box 18 and a second collecting box 20. The isolation bracket is installed at an upper end of the collecting module, and the first collecting box 18 and the second collecting box 20 are respectively located at both sides of a lower end of the isolation bracket. The first air-blowing port brackets 5 and the second air-blowing port brackets 38 are symmetrically installed in the isolation bracket. The first air-blowing port brackets 5 are located above the second collecting box 20, and air blowing ports of the first air-blowing port brackets 5 face the second collecting box 20. The second air-blowing port brackets 38 are located above the first collecting box 18, and air blowing ports of the second air-blowing port brackets 38 face the first collecting box 18.

The fresh tea leaves, after being fed by the electromagnetic vibration feeder 34, enter the shooting field of view of the color camera 2 in a parabolic trajectory, and the LED strips around both sides of the color camera 2 evenly illuminate the surfaces of the tea leaves, such that there is no shadow on the surfaces of the fresh tea leaves corresponding to a lens plane of the color camera 2. As the entire sorting module is covered with a brown glass cover, a photographed image of the fresh tea leaves is clearer against the blue background plate 3, thus improving the accuracy of tea grade recognition. When the fresh tea leaves pass through the background plate 3, the color camera 2 can quickly acquire the image of fresh tea leaves, and the acquired image has an actual length of 20 cm and a width of about 5 cm. Because there are many fresh tea leaf targets in an image area, each target needs to be regionally segmented first (i.e., firstly, a green channel gray image is extracted from the image obtained by the color camera 2, and then an average pixel value of the gray image is calculated, the gray image is binarized according to the average pixel value, and a white connected graph of each tea leaf target is extracted by a connected domain extraction method, and the tea leaf targets are segmented by the smallest circumscribed rectangle), the segmented fresh leaf target image is sent to a neural network classifier. After the classification is completed, the grade and position information are obtained. The time of the whole process from shooting to processing is calculated, the falling distance of the fresh tea leaves is calculated according to the time, and on/off of a solenoid valve of the air blowing port corresponding to the air-blowing port bracket is controlled, thus completing the grading of the fresh tea leaves. During collection, the fresh tea leaves that have been identified and positioned move downwards, and when the fresh tea leaves pass through the air-blowing port brackets, nozzles of multiple solenoid valves at corresponding positions are started to eject high-pressure airflow for effective grading of the fresh tea leaves. The first collecting box 18 is used to collect the fresh tea leaves blown out by the air-blowing port brackets on the right side, and the grade of fresh tea leaves is one bud with one leaf. The second collecting box 20 is used to collect the fresh tea leaves blown out by the air-blowing port brackets on the left side, and the grade of fresh tea leaves is one bud with two leaves. The inclined slideway 19 is used to collect broken leaves, stems, single leaves and some non-tea impurities in the picked fresh tea leaves, and discharge these substances to the tea field through the 30-degree inclined slideway 19, leaving only one bud with one leaf and one bud with two leaves in the picked fresh tea leaves.

Through the above design, while achieving the continuous picking of the famous tea, the effective sorting of the famous tea can be achieved, and the harvesting quality of the famous tea is improved.

Specific examples are used herein for illustration of the principles and embodiments of the present disclosure. The description of the embodiments is merely used to help illustrate the method and its core principles of the present disclosure. In addition, those of ordinary skill in the art can make various modifications in terms of specific embodiments and scope of application in accordance with the teachings of the present disclosure. In conclusion, the content of this specification shall not be construed as a limitation to the present disclosure.

What is claimed is:

1. An integrated harvesting device for picking and sorting famous tea, comprising a frame, a control module, and a traveling module, a picking module, a conveying module, a sorting module, a collecting module and a visual detection module which are electrically connected to the control module, wherein the traveling module is installed at a lower end of the frame, the picking module is installed on the frame and arranged adjacent to a front end and the lower end of the frame; the picking module is able to pick tea leaves with assistance of the visual detection module; the conveying module and the sorting module are both installed on the frame, the conveying module is configured to convey tea leaves picked by the picking module to the sorting module; the sorting module is configured to sort the tea leaves with assistance of the visual detection module, and enable sorted famous tea and ordinary tea leaves to enter different boxes in the collecting module.

2. The integrated harvesting device for picking and sorting famous tea according to claim 1, wherein the control module comprises a power supply, and a controller; the power supply is electrically connected to the controller and configured to provide electric energy; the controller is electrically connected to the traveling module, the picking module, the conveying module, the sorting module, the collecting module, and the visual detection module.

3. The integrated harvesting device for picking and sorting famous tea according to claim 1, wherein the traveling module comprises two crawler wheel boxes and four traveling units; two of the four traveling units, which are located on a same side, are externally mounted with one of the two crawler wheel boxes, the four traveling units are respectively installed at four corners of the frame; the four traveling units comprise direct current gear motors, gear chain sets, and crawler wheel sets; the direct current gear motors are installed at the lower end of the frame, output shafts of the direct current gear motors are connected to the gear chain sets, and the gear chain sets are further connected to the crawler wheel sets; each of the two crawler wheel boxes is covered on a periphery of corresponding two of the crawler wheel sets on the same side, and lower ends of the crawler wheel sets extend out of the crawler wheel boxes.

4. The integrated harvesting device for picking and sorting famous tea according to claim 1, wherein the picking module comprises a plurality of picking units arranged in sequence in a direction perpendicular to an advancing direction; each of the plurality of picking units comprises a translation element, a transverse sliding table, a first lifting element, a first vertical sliding table, and a picking part; the translation element is parallel to the advancing direction, and the transverse sliding table is movably installed on the translation element and capable of moving in a horizontal direction; an upper end of the first lifting element is connected to the transverse sliding table; the first vertical sliding table is movably installed on the first lifting element and capable of raising and lowering in a vertical direction; and the first vertical sliding table is connected to the picking part, and the plurality of picking units are able to pick the tea leaves.

5. The integrated harvesting device for picking and sorting famous tea according to claim 4, wherein the picking part comprises a gathering guide groove, a shunting baffle, a second lifting element, a second vertical sliding table, a brushless motor, and a blade set; the gathering guide groove, the shunting baffle and the second lifting element are installed on the first vertical sliding table; the shunting baffle comprises two shunting unit plates; ends of the two shunting unit plates are fixedly connected to form a guide angle facing the front end of the frame; from the front end to a rear end of the frame, the two shunting unit plates extend in directions away from each other, and then extend parallel to each other; the guide angle is located at a middle part of the gathering guide groove, an other end of each of the two shunting unit plates extends to be flush with an end of the gathering guide groove, and the two shunting unit plates respectively form two picking grooves with inner walls of the gathering guide groove; the second vertical sliding table is movably installed on the second lifting element and capable of raising and lowering in the vertical direction; the brushless motor is installed on the second vertical sliding table, and an output shaft of the brushless motor extends out between the two shunting unit plates and is connected to the blade set; an other end of the gathering guide groove is configured for the tea leaves to enter, the guide angle is configured to divide the tea leaves entering the gathering guide groove into two groups, and enable the two groups of the tea leaves to respectively enter the two picking grooves; and the blade set is configured to cut and pick the tea leaves in the two picking grooves.

6. The integrated harvesting device for picking and sorting famous tea according to claim 5, wherein each of the translation element, the first lifting element and the second lifting element is a lead screw-guide rail set.

7. The integrated harvesting device for picking and sorting famous tea according to claim 1, wherein two air compressors are respectively installed on two sides of the lower end of the frame, each of the air compressors is connected to a wind box, a plurality of first air ducts and a plurality of second air ducts are respectively connected to the two air compressors, an end of each of the plurality of first air ducts extends to the picking module, and is configured to blow tea leaves picked by the picking module to the conveying module; and an end of each of the plurality of second air ducts extends to the sorting module, and is configured to blow different grades of tea leaves at the sorting module to different boxes in the collecting module according to tea grade information detected by the visual detection module.

8. The integrated harvesting device for picking and sorting famous tea according to claim 7, wherein the conveying module comprises a telescopic sliding plate, a first conveyor belt and a second conveyor belt which are installed on the frame; an end of the telescopic sliding plate is arranged adjacent to the picking module, the telescopic sliding plate is able to extend and retract in an advancing direction, and an other end of the telescopic sliding plate extends to an end of the first conveyor belt; the plurality of first air ducts are able to blow the tea leaves picked by the picking module to the telescopic sliding plate and the first conveyor belt, an other end of the first conveyor belt extends to a lower end of the second conveyor belt, and an upper end of the second conveyor belt extends to a position above the sorting module; in the advancing direction, a height of the first conveyor belt decreases gradually, a plurality of first baffles perpendicular to a surface of the first conveyor belt are equidistantly distributed on the surface of the first conveyor belt, a length direction of the plurality of first baffles is perpendicular to the advancing direction; the plurality of first baffles are able to convey the tea leaves to the second conveyor belt; a plurality of second baffles perpendicular to a surface of the second conveyor belt are equidistantly distributed on the surface of the second conveyor belt, and a length direction of the plurality of second baffles is perpendicular to the advancing direction; inclined plates are connected to ends, away from the surface of the second conveyor belt, of the plurality of second baffles, an included angle between each of the inclined plates and a corresponding one of the plurality of second baffles is an obtuse angle, and the inclined plates and the plurality of second baffles are able to drive the tea leaves to move upwards to fall on the sorting module.

9. The integrated harvesting device for picking and sorting famous tea according to claim 7, wherein the visual detection module comprises color cameras, a hyperspectral camera, and a structured light camera; the color cameras are installed adjacent to the sorting module and configured to detect quality of the tea leaves; the hyperspectral camera and the structured light camera are arranged adjacent to the picking module; the hyperspectral camera is configured to identify bud heads of the tea leaves on a canopy; and the structured light camera is configured to position the bud heads of the tea leaves on the canopy.

10. The integrated harvesting device for picking and sorting famous tea according to claim 9, wherein the sorting module comprises an electromagnetic vibration feeder, an isolation bracket, a sorting cover, light-emitting diode (LED) strips, background plates, and two groups of air-blowing port brackets; a periphery of the isolation bracket is covered with the sorting cover, the tea leaves at a discharge port of the electromagnetic vibration feeder are able to enter the isolation bracket; the collecting module comprises two collecting boxes, and an inclined slideway is arranged between the two collecting boxes; the isolation bracket is installed at an upper end of the inclined slideway, and the two collecting boxes are located at two sides of a lower end of the isolation bracket, respectively; the inclined slideway is able to communicate with an internal of the isolation bracket, the two groups of air-blowing port brackets are symmetrically installed on the isolation bracket and in communication with the plurality of second air ducts, and the air-blowing port brackets are in one-to-one correspondence with the collecting boxes; the air-blowing port brackets are configured to blow the tea leaves into corresponding collecting boxes with assistance of the color cameras; and when the two groups of air-blowing port brackets are not at operation, the tea leaves fall into the inclined slideway; a plurality of feeding grooves are formed in an upper surface of the electromagnetic vibration feeder, which are in one-to-one correspondence with the color cameras, and the color cameras are installed at an upper end of the isolation bracket and arranged adjacent to discharge ports of the feeding grooves; the LED strips comprise two groups of LED strips, the two groups of LED strips are installed on the isolation bracket and are respectively located at upper and lower sides of the color cameras; and the background plates are installed on the isolation bracket and is opposite to the color cameras.
